(19) United States
(12) Patent Application Publication
(10) Pub. No.: US 2019/0320811 A1
(43) Pub. Date: Oct. 24, 2019

(54) Method of making mattress core with individual foam columns and no springs.

(71) Applicants: James R. Malkiewicz, Sacramento, CA (US); Michael Malkiewicz, San Diego, CA (US); Michael Breckle, Northheim (DE)

(72) Inventors: James R. Malkiewicz, Sacramento, CA (US); Michael Malkiewicz, San Diego, CA (US); Michael Breckle, Northheim (DE)

(21) Appl. No.: 16/392,416

(22) Filed: Apr. 23, 2019

Related U.S. Application Data
(60) Provisional application No. 62/661,787, filed on Apr. 24, 2018.

(51) Int. Cl. A47C 27/14

(52) U.S. Cl. CPC A47C 27/148; B29C 63/025; A47C 27/142

(57) ABSTRACT

This invention is a mattress core that is manufactured as a single unit. It is made up of individual cones that have different configurations resulting in different densities at different portions of the mattress. There are three main ways to accomplishing this goal: columns of different sizes and shapes, columns with different hole diameters, and columns with different density foam used to create them. A key advantage of this invention is that it is a single mattress made from a single mold and does not require multiple parts to be put together.

### CROSS REFERENCE TO RELATED APPLICATIONS

This application claims priority to U.S. Provisional No. 62/661,787, filed 2018 Apr. 24, the contents of which are incorporated by reference.

### STATEMENT REGARDING FEDERALLY SPONSORED RESEARCH OR DEVELOPMENT

This invention was not federally sponsored.

### LIST OF REFERENCE NUMBERS

1. Mattress core
2. Top Edge
3. Side Edge
4. Side Channels for Air Flow
5. Bottom Edge
6. Column
7. Main Mattress Body
8. Foot
9. Hole
10. Bulb
11. Base
12. Connector
13. Column Height
14. Main mattress body
15. Mattress bottom
16. Column width
17. Foot generally
18. Foot side
19. Foot top
20. Foot hole

### BACKGROUND OF THE INVENTION

The combination and reactions produced thereof produce a unique mattress core that can be utilized in many different ways. In addition to other configurations, the core may be manufactured with a number of individual, resilient elements, generally referred to as columns which may be in a variety of shapes. Also, these shapes may be configured in a variety of positions and placements in the mattress to affect firmness and comfort for the sleeper. The standard thickness of these cores is usually at a maximum of 17.5 cm but may also be made as thin as 10 cm. It is also conceivable that two of the cores may be glued together to make one large core. This is done to overcome the height limitations that some tools can present. To this end, a method of making a mattress with a large number of individual resilient members is described. The height and amount of resiliency are varied among the columns to give the mattress different degrees of firmness at different parts of the mattress.

By way of a summary of the invention, the mattress is created on a table that rotates in a sort of carousel manner. It is contemplated, however, that non-rotating tables with rotating molds are also contemplated. Indeed, a variety of combinations of rotating tables and rotating molds is contemplated with the goal of making a unique, one-piece mattress. There are several molds situated in various locations around the table.

The cleaning process by which the molds are cleaned between uses is also important. Any residue left behind after a mattress is made is then picked up by the raw foam injected into the mold for the next mattress. This results in a mattress with visible defects, and, over time, leaving reside on a mold can lead to imperfections in the mold that will be passed on to every mattress made by that mold.

To rectify this problem, the invention provides two different methods by which any residue is removed before foam for a new mattress is injected. First, a visual inspection of the mold is made and any visible particles are removed with needle-nosed pliers, picks or similar instruments. Second, a quick-drying coat of PVC or another plastic is sprayed onto the sides of the mold by a rotating arm, allowed to cool and harden, they physically pulled off, thereby removing any smaller particles that were not seen during the visual inspection.

Each mold can be loaded with different densities and even different combinations of chemical mixtures of foam, derived from a number of different chemical formulas, and each mold can be individually heated and/or cooled as desired through a computer program that can provide different sets of instructions for different projects. The table in one embodiment is freely rotatable and can be angled if needed for the mattress creation process, while in another, preferred embodiment the table is stationary and the arm is rotatable.

It is desirable to be able to manufacture a mattress where different regions of the mattress have different degrees of firmness. Since humans are not built flat, it is desirable to have a mattress that has denser regions near the person's midsection, where the bulk of a person's weight is located.

A problem with traditional coiled wire mattresses is that while it is possible to insert springs of different degrees of compressibility, it is expensive to do so. While coil mattresses have been around since the 1800's, the last major innovation in spring mattresses occurred in the 1950's with the continuous coil. Thus, many consumers are looking for a more modern, innovative product. Additionally, mattresses are a major problem in landfills. Mattresses with springs are very difficult to take apart to take up less room in a landfill, and many states and local governments are passing laws several restricting and otherwise regulating the disposal of mattresses. The “pocketed coil” is the most popular spring mattress on the market today, and has a spring coil that is covered with fabric. This is extremely difficult to dispose of, as the fabric needs to be removed by hand from each coil before recycling, thus it is very labor-intensive as there are no recycling machines capable of shredding and sorting a spring mattress.

The different components of a coil mattress also make it illegal to dispose of them through incineration in many states. Smokestacks in incinerators have different scrubbers to remove different pollutants, and the pollutants from fabric, foam, wood and steel are very different. Thus, you can't just throw an old spring mattress in an incinerator and be done with it; you must physically separate the individual components first.

Applicants' invention, on the other hand, mimics the usefulness of the spring system without the end-of-life problems. A foam mattress does not require expensive steel. Foam mattresses are also easily recycled, as they are merely run through a shredder and the shredded foam can be used for a wide range of products.

Foam mattresses are not new. The prior art has many foam mattresses made by traditional methods, but none of them can match the performance of Applicants' invention. The current method of making a foam mattress is to use “slab stock foam” to make a base for the mattress. Slab stock foam can be inconsistent. It is made in huge “buns” 100′ long and four to six feet high. As with a loaf of bread, when you pour all that plastic into a mold and let it “rise” into foam there will be pockets of greater and lesser density, air holes, etc. The slab stock foam is then sliced into slabs the size of the mattress, and laid down as the bottom layer, but the manufacturer's certainty as to the quality of the slab can be called into question.

Slab stock foam also can be of poor quality with respect to its resilience, as one of its purposes is to add height to the mattress. While most slab stock foam has a density of around 1.5 to 1.8 pounds/square inch, Applicants' invention is made such that their foam has a density of 3.8 pounds/square inch. In addition, every time foam is cut, it loses some resiliency. In short, slab stock foam is a less than desirable substitute for metal springs in terms of providing resiliency to a mattress.

Above the slab stock bottom, there are a number of ways that foam mattress manufacturers try to make the mattress more resilient. This includes adding additional layers of foam, or adding individual cones that are glued in place. While these layers do provide some resiliency, they represent only about 30% of the mattress, thus many foam mattresses are using less than a third of their height to provide comfort to the user.

There exist mattresses made of foam where different elements have different configurations such that certain portions of the mattress and be firmer or less firm than other regions of the mattress. However, these mattresses are generally manufactured in a manner not all the more efficient than building springs of different compressibility and manually inserting them into the mattress. The foam mattresses are generally created by taking small groups of 2 to 6 elements of different configurations and placing them onto a bottom portion with a perimeter, gluing them in place, the gluing a top layer over the top of the elements. While this method also accomplishes the goal of creating a mattress with different degrees of firmness in different areas, it is difficult, expensive and time-consuming to create, and as with any process that involves human judgment, errors are always a possibility. Applicants' process, on the other hand, allows their core to be made with more accuracy so that the density is exponentially more consistent throughout the mattress. It is much easier to control density and consistency with a single mold and a single pour of foam into it, than it is to take slab stock foam and hope you are getting a consistent piece, then glue in some cones, hoping your employees put the right ones in the right part of the mattress, then glue over another piece of slab stock foam

As with any mold, a mattress mold can become “pitted” over time if it is not cleaned regularly and properly. To rectify this problem, the invention provides two different methods by which any residue is removed before foam for a new mattress is injected. First, a visual inspection of the mold is made and any visible particles are removed with needle-nosed pliers, picks or similar instruments. Second, a quick-drying coat of PVC or another plastic is sprayed onto the sides of the mold, allowed to cool and harden, they physically pulled off, thereby removing any smaller particles that were not seen during the visual inspection.

So, while the prior art has several examples of mattresses where different portions have different densities and degrees of firmness, all of this prior art is relatively expensive and requires significant time for the workers to put each mattress together.

Thus, there has existed a gap in the current line of mattresses for a mattress that has different regions with different densities that can be manufactured inexpensively and efficiently.

The current invention provides a solution to these problems by providing a method of making a mattress core that is manufactured as a one-part item with cones of different shape and configuration offering a mattress core with different densities that needs no human effort other than operating the mold. The mattress as described in this provisional patent application can achieve this end through three separate means, which could also be used in combination:

1. Columns of different heights and shapes.

2. Columns with holes of different diameters.

3. Columns of different densities of foam.

A preferred embodiment of this invention is to have a single piece of foam manufactured in a single mold, such that the consistency of the foam can be easily monitored and controlled, with individual columns of different heights and geometric shapes in different regions of the mattress core. Each column has a hole in the center, and the size of the hole will affect the resiliency of each column. The mattress core has side channels molded into it which help with air flow onto and out of the mattress. Because the air holes and the side channels are part of the mold, they do not have to be cut into the mattress after it is created, thereby decreasing the resiliency of the foam.

Because each column is molded in place, there is no need to individually glue in any cones—indeed no manual labor or glue is necessary as the mattress core comes out of the mold ready to use. With a single mold, a higher quality and density of foam can be used, thus Applicants' mattress core mimics the comfort of a spring mattress such as a pocketed coil mattress without any of the recycling/disposal problems. Because the entire core is made of the same consistent quality of foam, the entire unit provides comfort as opposed to a traditional foam mattress where 70% is intended to be giving the mattress height and only 30% designed toward the comfort of the user.

In addition, because this invention uses a single mold, it is possible to “zone” the mattress core to allow for different support characteristics in different portions of the mattress, as opposed to the prior art which requires a manufacturer to glue different cones into different areas or manipulate foam in such a manner that the quality and consistency of the foam can be compromised.

There are existing machines and methods of using them that have attempted to create similar products.

U.S. Pat. No. 4,421,468 to Bokelmann teaches a “Foam Molding machine” that includes a rotatable table with many molds which are computer-controlled to open and close as desired. This invention, however, is design for significantly smaller products that the mattresses made by the current method and could not make a contiguous mattress. A mattress made from only one “pour” is desirable over a mattress that is put together from pieces that were individually made and then glued together, and a single mattress made by foam injection will be superior to a mattress made through this item of prior art.

More prior art is found in an invention entitled “Method of molding polyurethane foams in steam heated molds and adhesion steam condensate is used to cool the molds” to Osswald, et. al. This patent describes the use of a foam molding apparatus where individual molds are filled with a flowable foam-material mixture which can be hardened, heated and cooled as desired. The invention includes a rotatable table with several molds for hot-foam molded articles, where each mold can be independently heated and/or cooled as desired. However, as with the Bokelmann invention, this invention does not allow for the creation of a large, one-piece contiguous article the size of a foam mattress.

The concept of using foam cones in a mattress has also already been done. For example, US20100218318A1 to Steppart. et. al. illustrates how a mattress manufacturer can independently create foam cones and then insert these foam cones into an existing mattress “bed”. However, this does not teach the currently invention's ability to create an entire contiguous mattress out of a single pour of foam. A single foam mattress that has had the various cones of varying densities, heights, geometric shapes etc. molded into the mattress during its creation has numerous advantages. First, it is less expensive and time-consuming to create a single foam mattress in one pouring or injection than in creating hundreds of different pieces and then assembling them. Second, a contiguous mattress without hundreds of glue lines holding the parts together will be more comfortable and more durable.

A prior art that could form one of the individual cones that make up a mattress created by the method taught by Steppart can be found in U.S. D600,541 for a “Tube”, which shows a design of a cone, or “tube”. Hundreds of these cones or tubes could be individually inserted and glued into a mattress per the method described by Steppart, but again, creating a mattress that is more expensive, potentially less comfortable the use of too much rigid glue results in a vertical, rigid glue line, and takes a longer time to manufacture.

The prior art includes another design patent—D606,794—to Steppart. The patent teaches a rectangular shaped mattress, but does not provide a method by which an entire foam mattress can be created from a single pouring “spring element”

### SUMMARY OF THE INVENTION

It is a principal object of the invention to provide a method of making a mattress that can be manufactured as a single contiguous unit without the need for any cutting or gluing.

Other objects of the invention include:

Being able to manufacture the mattress out of a single mold, with no construction time and effort needed to create it other than overseeing the molding process—in other words, no time to take individual cones or small groups of cones and glue them into position,
having different parts of the mold create columns of different size and shape such that each cone imparts to the mattress core a different density and resilience,
having different sized holes in the middle of the cones such that each cone imparts to the mattress core a different degree of firmness and resilience,
being able to create a mattress core without doing any foam cutting to create it,
being able to use a higher quality and density of foam than is currently used in traditional foam mattresses,
having side channels molded into the mattress core as opposed to being cut by hand or machine,
having different densities of foam inserted into different parts of the mattress to create regions with different density and resilience through a multi-nozzle pour system.

Another object of the invention is to provide an inspection and cleaning process that keeps the mold clear before foam for the next mattress is injected.

It is a final object of this invention to provide method of making a single, contiguous mattress core through the creation of a single mold with individual cones within that mold having different shapes, where the different shapes result in cones of different degrees of firmness and purposes in the mattress.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims.

Method of Making the Mattress

To describe the method of making the mattress in more detail, we will follow the process through its sequential steps.

First, the table upon which the mattress is made has a number of molds, each with its own heating and cooling machines, and an optionally stationary or movable “filling machine” that can be used to fill each mold with a certain quantity of a certain mixture of foamable reaction mixture. Before injection of foam, a visual inspection of the mold is made and any visible particles are removed with needle-nosed pliers, picks or similar instruments. Second, a quick-drying coat of PVC or another plastic is sprayed onto the sides of the mold, allowed to cool and harden, they physically pulled off, thereby removing any smaller particles that were not seen during the visual inspection.

The foamable reaction mixture has more than one component and these components can be varied depending on the desired end product, and are controlled by a meter of sorts. The molds are opened and closed by a computer program depending on the desired end result. It is envisioned that each mold could be controlled by a separate circuit board, logic chip or mini-computer, with all of these controlled by a master computer.

The table is not always horizontal in orientation, but rather can be tilted and rotated to effectively create the mattress. The table is preferably circular, but other shapes, such as hexagons and rectangles are contemplated. It is also contemplated that a linear production method with an automatic fill head moving in a linear fashion between molds could be utilized. The number of molds can be anywhere from 2 to potentially an infinite number, but generally 4 to 32 molds are ideal. The table can be rotated by any known means, but gears that mate with gear teeth are a preferred embodiment. Molds are held by molding frames, that can be permanent or temporarily attached to the surface of the table.

Each mold has its own, independently controlled heating and cooling elements. The heated or cooled substance is distributed evenly over the mold through a distribution network. In a preferred embodiment, steam is used for heating and cold water is used for cooling, but other substances for heating and cooling are contemplated.

The molds are “fed” foamable mixtures from the filling arms. Each foamable mixture is created through a computer-controller filling operation that connects with the filling arms, which are, optionally, stationary or movable. Once the mold has been filled with the correct composition and amount of foamable mixture, it is heated by steam or another heating substance to the temperature necessary to create the correct amount and type of foam, which is then extruded into the mattress. Once the desired amount of foam has been extruded, the mold closes and is cooled by the cooling substance, which in most cases is water.

After the mattress has cooled adequately to be removed, the aforementioned inspection and cleaning process is initiated before foam for the next mattress is injected into the mold.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a perspective view of mattress with the individual columns in a straight-line configuration as has been manufactured by this process.

FIG. 2 is a perspective view of the bottom of a mattress core as described in this patent application, showing the “solid” version as has been manufactured by this process. There is a second version, where the hole in the column extends all the way through the mattress. This is illustrated in FIGS. 9-13.

FIG. 3 is a top view of a mattress with the individual columns in a straight, in-line configuration as has been manufactured by this process.

FIG. 4 is a top view of a mattress with the individual columns in a staggered configuration as has been manufactured by this process.

FIG. 5 is a side view of the mattress showing the side channels that allow for air to enter and exit the main mattress body as has been manufactured by this process.

FIG. 6 is an end view (either top or bottom) showing the lack of side channels as has been manufactured by this process.

FIG. 7 is a perspective view of an individual column, showing the foot portion (that is part of a continuous mattress body) and the head portion that sticks up in the air as has been manufactured by this process.

FIG. 8 is a front view of an individual column as has been manufactured by this process.

FIG. 9 is a cross sectional view of an individual column, showing the “solid bottom” version of the invention where the hole in the column does not extend through the bottom of the mattress as has been manufactured by this process.

FIG. 10 is a perspective cross-sectional view of the main mattress body showing how a number of columns are formed with one mold as has been manufactured by this process.

FIG. 11 is a cross sectional view of a main mattress body showing how the connectors connect the columns to each other in the “solid bottom” version of the invention as has been manufactured by this process.

FIG. 12 is a cross sectional view of a main mattress body showing how the connectors connect the columns to each other in the version of the invention where the holes go all the way through the column, through the mattress bottom as has been manufactured by this process.

FIG. 13 is a perspective view of the bottom of a mattress in the embodiment of the invention where the holes go all the way though the mattress bottom as has been manufactured by this process.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

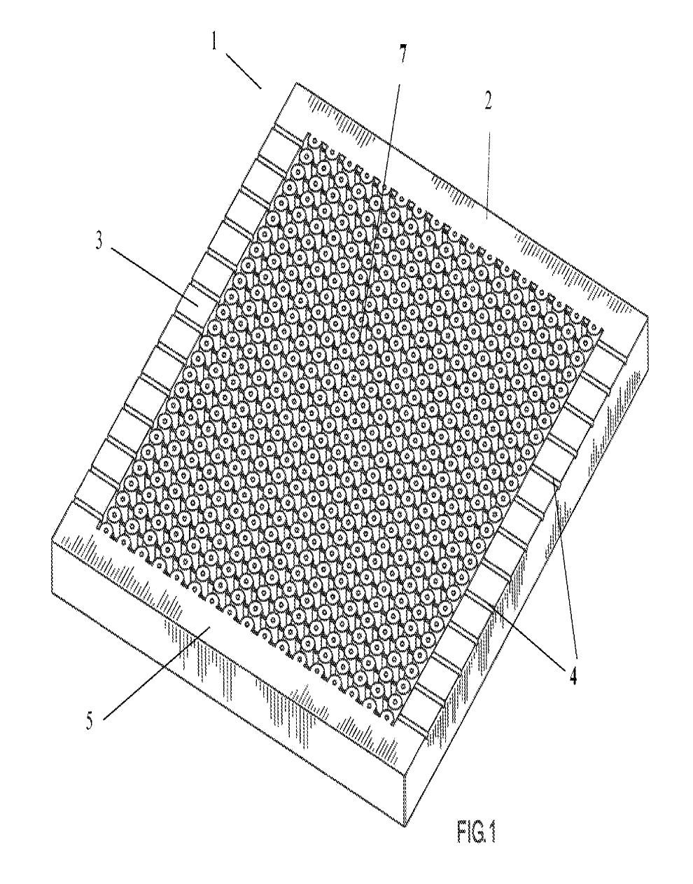

FIG. 1 is a perspective view of mattress with the individual columns in a straight-line configuration as has been manufactured by this process. The mattress, generally referenced as 1, has a main mattress body 7 that is bounded on the top by a top edge 2, bounded on the bottom by a bottom edge 5, and on the sides by two side edges 3. In the side edges are side channels 4, which allow air to flow into and out of the main mattress body 7. Because these side channels are molded into the mattress core, there is no loss of resiliency as is the case where side channels are cut into the foam. The main mattress body is made up of many columns, which are attached to the base of the main mattress body and manufactured as part of a single unitary constructed mattress body. With columns (reference number 6 in later figures) of different height, shape, and density, the goal of the invention is to create a mattress core with different densities in different parts of the mattress core without having to “put together” the mattress from assorted parts, but instead, to create the mattress as single foam body.

As it is essential to keep the mold clean, the invention provides two different methods by which any residue is removed before foam for a new mattress is injected. First, a visual inspection of the mold is made and any visible particles are removed with needle-nosed pliers, picks or similar instruments. Second, a quick-drying coat of PVC or another plastic is sprayed onto the sides of the mold, allowed to cool and harden, they physically pulled off, thereby removing any smaller particles that were not seen during the visual inspection.

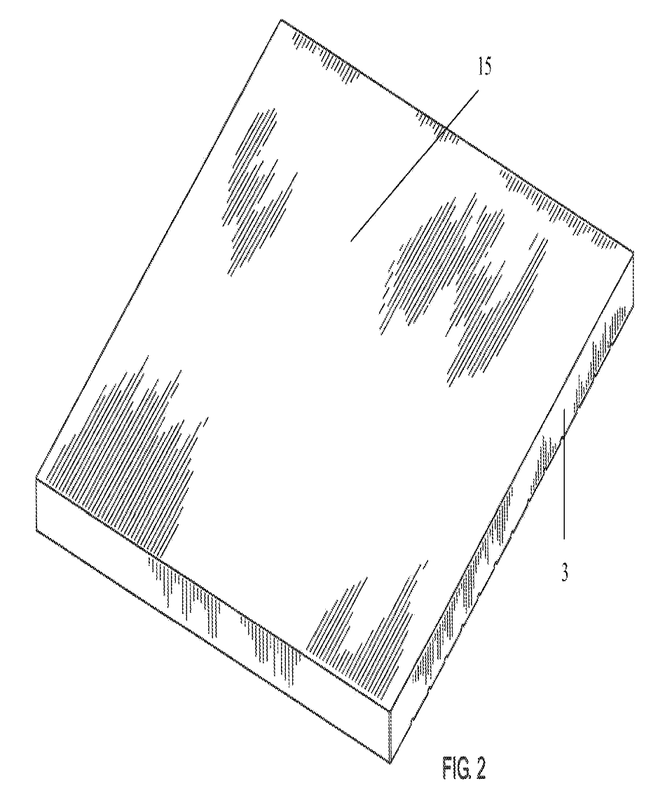

FIG. 2 is a perspective view of the bottom 15 of a mattress core as described in this patent application as has been manufactured by this process. The bottom is flat.

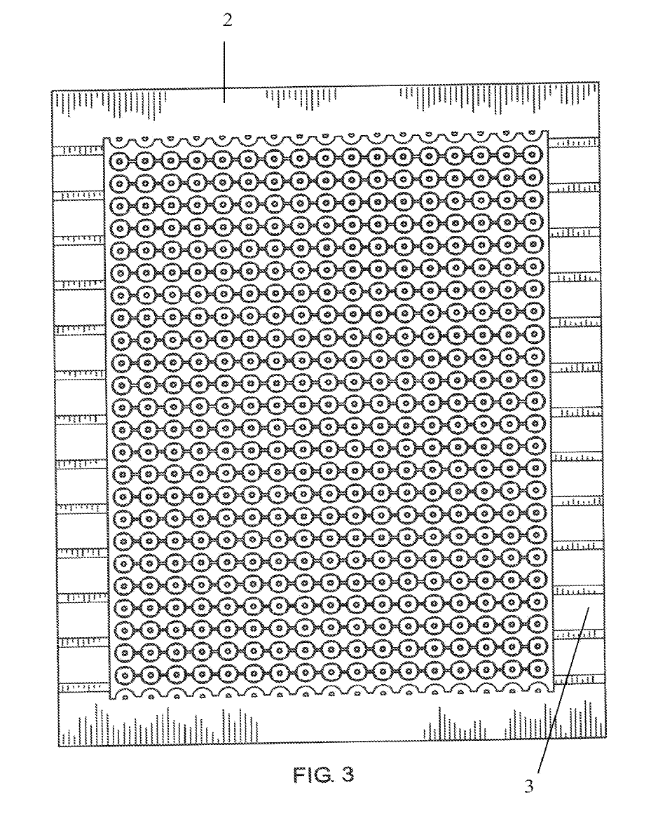

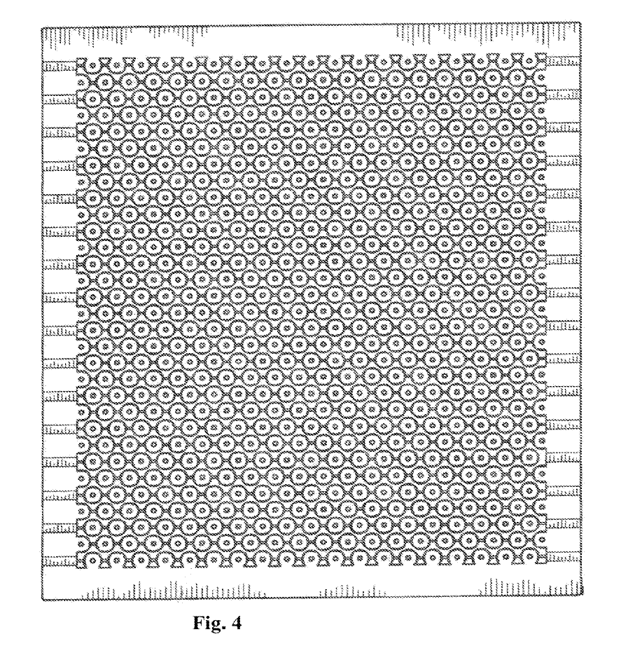

FIG. 3 is a top view of a mattress with the individual columns in a straight, in-line configuration as has been manufactured by this process, and FIG. 4 is a top view of a mattress with the individual columns in a staggered configuration as has been manufactured by this process. These alternative alignments can be used to affect different performance characteristics.

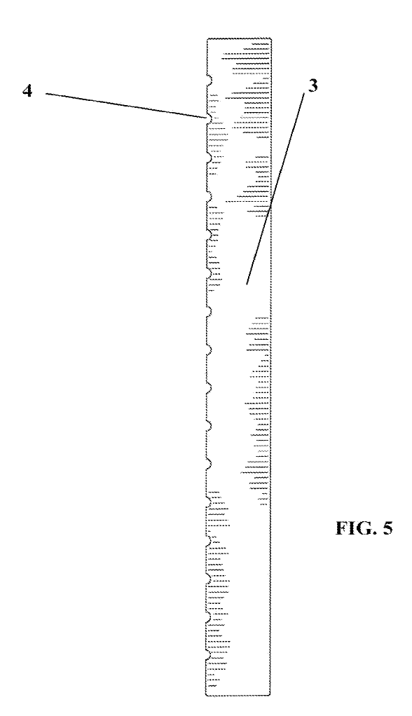

FIG. 5 is a side view of the mattress showing the side edge 3 and the side channels 4 that allow for air to enter and exit the main mattress body as has been manufactured by this process.

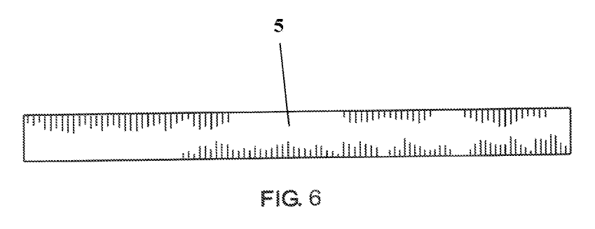

FIG. 6 is an end view (either top or bottom) showing the lack of side channels as has been manufactured by this process.

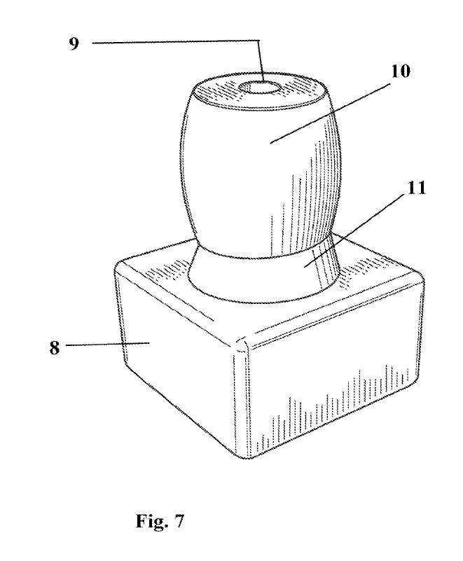

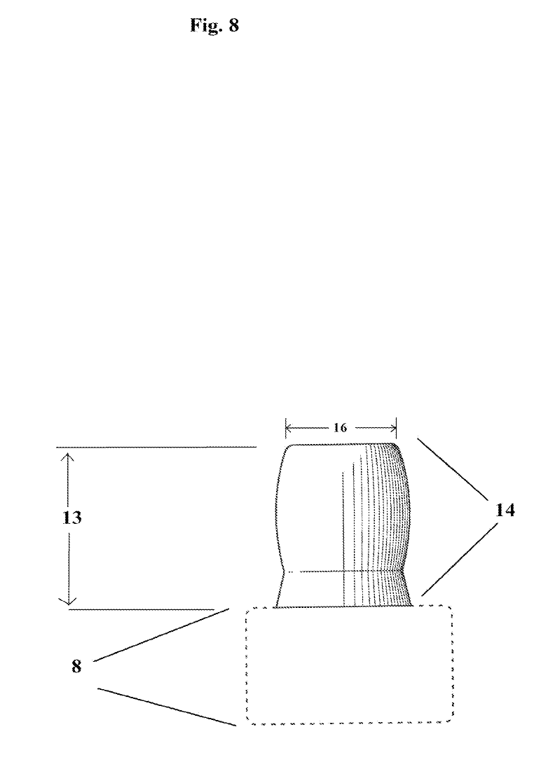

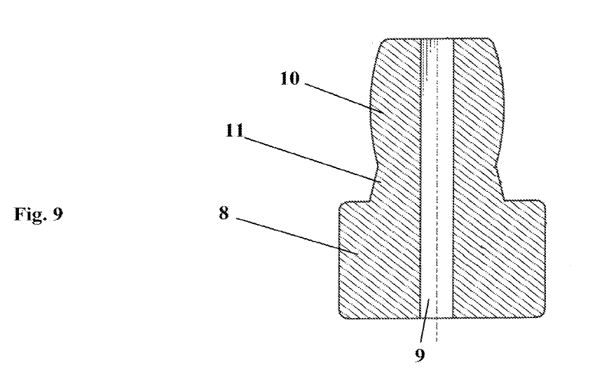

FIG. 7 is a perspective view of an individual column as has been manufactured by this process, showing the foot portion 8 (that is part of a continuous mattress body) and the head portion 14 that sticks up in the air. FIGS. 8 and 9 are cross sectional views of an individual column, showing the foot 8 and the head portion 14. The head portion 14 has a hole 9 in the center. The diameter of the hole 9 can be enlarged to create a column with lower resiliency, or decreased to create a column with increased resiliency. Because the hold is in the mold, it does not have to be cut by hand or machine, thereby not losing any density or resiliency. The head portion also has a bulb 10, which is an enlarged section, and a base 11, which transitions from the bulb 10 to the foot 8. It should be noted that foot 8 extends the entire area of the main mattress body, and all columns are manufactured as part of the mattress. The head portion also has a height 13 and a width 16, which can be varied between columns to provide different amounts of resiliency.

It can be seen from this view how by increasing the height, widening the bulb 10, making the bulb 10 from a denser foam, or decreasing the diameter of the hole 9, it would be possible to create individual columns with different densities. Creating a mold where all the columns in a certain region of the mold are similarly designed, it can be seen how the invention can be manufactured such that each section could have a different density and resiliency.

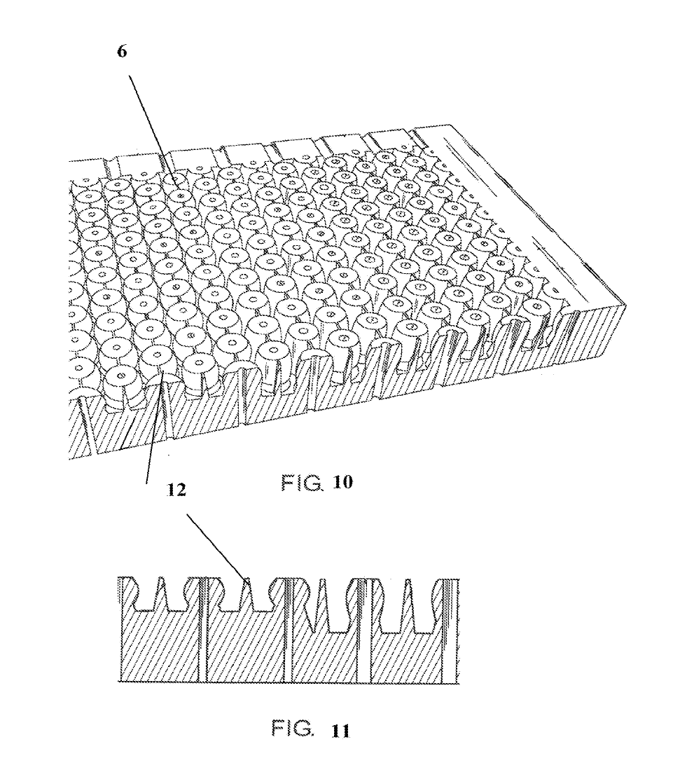

FIG. 10 is a perspective cross-sectional view of the main mattress body as has been manufactured by this process showing how a number of columns are formed with one mold.

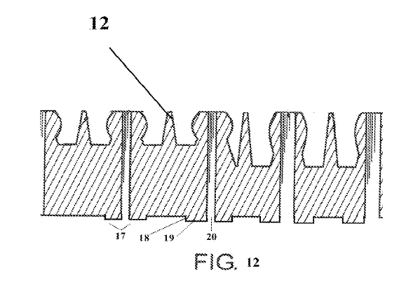

FIG. 11 is a cross sectional view of a main mattress body as has been manufactured by this process showing how the connectors 12 connect the columns 6 to each other. The connectors serve to anchor the columns from moving too much laterally.

FIG. 12 is a cross sectional view of a main mattress body as has been manufactured by this process showing how the connectors connect the columns to each other in the version of the invention where the holes go all the way through the column, through the mattress bottom. The part of each column section protruding from the plane of the bottom of the mattress is called a “foot” 17. The foot 17 has a foot side 18, which gives it a certain foot height, and a foot top 19, which gives is a certain foot width. In the center of the foot 17 is a foot hole 20, which extends up through the column to the top of the mattress.

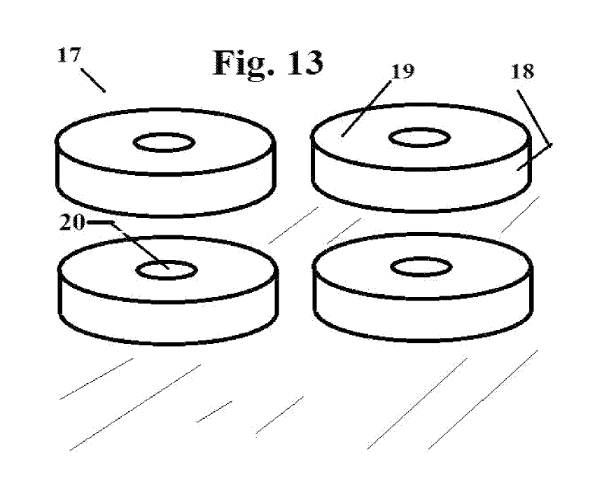

FIG. 13 is a perspective view of the bottom of a mattress as has been manufactured by this process in the embodiment of the invention where the holes go all the way though the mattress bottom. Each foot 17, has a foot hole 20, through which air can rush as the mattress is being compressed by a person laying down on it. The height of the foot side 18 can be adjusted to accommodate different weights and desired compression characteristics.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What which is claimed:

1. A method of making a mattress, where the method comprises the steps of obtaining a mattress forming table, where the mattress forming table has two or more molds, where each of the two or more molds has a separate heating control and a separate cooling control, where a computer controls the separate heating control and the separate cooling control for each mold, and where the resulting mattress comprises a mattress core, comprising a top edge, a bottom edge, two side edges, where the top edge, bottom edge and side edges are joined at approximately a 90 degree angle to one another, a mattress bottom, and a mattress main body, where the mattress main body is bounded by the top edge, the bottom edge and the two side edges, and where the mattress body additionally comprises at least two columns, where the at least two columns have a head and a foot, where the foot is a continuous piece of foam extending the entire mattress body, and the head is bounded by air on at least 75% of its diameter and extends vertically from the mattress body, and additionally comprising a cleaning and preparation procedure that ensure that the mattress forming table is adequately prepared to smoothly and efficiently produce one or more mattresses.

2. The method of claim 1, where each mold has heating and cooling means, and where the mattress core is a single piece of foam and where each one of the at least two columns additionally comprises a hole that extends throughout the column.

3. The method of claim 2, where the heating means is steam and where the side edges additionally comprise side channels which enhance the flow of air into and out of the mattress core.

4. The method of claim 3, where cooling means is cold water, and the bottom additionally comprises one or more foots, where each of the one of more foots is the bottom portion each of the one or more columns, and where each foot has a foot top and a foot side, where the foot side is a cylinder extending around the foot, and where the foot top is a flat surface, and a foot hole, where the foot hole is a cavity extending from the foot top through the column, and where each foot has a foot spacing, which is the distance between a particular foot and an adjacent foot.

5. The method of claim 4, where the head additionally comprises a bulb and a base, where the bulb is a roughly cylindrical shape and has a top diameter, a middle diameter, and a bottom diameter, where with a middle diameter is larger than both the top diameter and the bottom diameter, and where the head has a density, a height, and a width.

6. The method of claim 5, additionally comprising a connector, where the connector comprises a ridge of foam with a length longer than a width.

7. The method of claim 6, where the connector bridges at least one column to another column or to the top edge, bottom edge or side edges.

8. The method of claim 7, where at least one at least two columns has a difference from at least another column of the at least two columns and where the cleaning and preparation procedure additionally comprises a rotating arm.

9. The method of claim 8, where the difference is differences in density of the foam used to create the two heads.

10. The method of claim 8, where the difference is different diameters of holes in the head.

11. The method of claim 8, where the difference is different shapes of the at least two columns.

12. The method of claim 8, where the difference is different heights of the at least two columns.

13. The method of claim 8, where the difference is different widths of the at least two columns, and different spacing between one or more of the at least two columns.

14. The method of claim 8, where the difference is different heights and different widths of at least two of the at least two columns.

15. The method of claim 8, where the difference is different densities and different heights and different widths of at least two of the at least two columns.

16. The method of claim 1, where the table additionally comprises means of rotating the table.

17. The method of claim 16, where the means or rotating the table are gears.

18. The method of claim 16, where the method additionally comprises using a computer to mix a quantity of foamable mixture for each mold.

19. The method of claim 18, where the method additionally comprises means of expelling the foam in a desired pattern.

20. The method of claim 19, where the method additionally comprises means of cooling the mold after a desired quantity of foam has been expelled.
